(19) United States
(12) Patent Application Publication
(10) Pub. No.: US 2017/0103065 A1
(43) Pub. Date: Apr. 13, 2017

(54) System for verifying the integrity of a document

(71) Applicant: Paul A. Coyne, Denver, CO (US)

(72) Inventor: Paul A. Coyne, Denver, CO (US)

(21) Appl. No.: 14/881,764

(22) Filed: Oct. 13, 2015

(51) Int. Cl. G06F 17/30

(52) U.S. Cl. CPC G06F 17/30011; G06F 17/30309; G06F 17/30371

(57) ABSTRACT

A system to verify the integrity of a document generates a member ID for each member that signs up to draft a document, generates a checksum code when the document is complete, either through inquiry of the member by the system or otherwise, and associates the checksum and member ID with the completed document. The system displays the member ID and checksum on the document whenever it is printed or displayed electronically. Upon inquiry of a member ID and checksum, the system returns information that the document is or is not the most recent version, or that it cannot be determined if the document is the most recent version. The checksum can be in the form of an alphanumeric string of characters, a bar code, or a 2-dimensional matrix code, and is at least in part based on the content of the document, or the length of the document.

### BACKGROUND OF THE INVENTION

Field of the Invention

The present invention relates in general to the field of document handling, and more particularly, to a system for verifying the integrity of a document.

Description of Related Art

A document often gets revised, and may have several versions before the final version is complete. Even after the document is complete, there are often circumstances that require later editing, updating, or other after final revisions. While there exists word processing software packages that can save and access prior versions of a document, they do not identify if a version is the most recent version of a document. Such information is important when dealing with documents such as a last will and testament, advance medical directives, and other significant documents that may be revised.

An advance medical directive, also known as living will, personal healthcare directive, advance directive, or advance decision, is a document in which a person specifies what actions should be taken for his or her healthcare if he or she is no longer able to make or communicate medical treatment decisions because of illness or catastrophic injury. In the electronic advance medical directive field, a person prepares a directive electronically by answering a series of questions that then are used to create a document. At any time, that document may be printed, revoked, voided, revised, updated, or otherwise changed. At some later time, the person may need emergency, critical or end-of-life medical care, and the health care provider will need not only to reference the advance directive, but also to know that the advance directive that he or she is referencing is the most recent version, and if not the most recent version, to be able to access the most recent version, if available.

Other situations where the health care provider or hospital would not be able to rely on the version of an advance directive on file include when the person is no longer using the electronic advance directive company used to create the earlier advance directive, or during a time when the person is revising the advance directive and wishes that the previous version of the advance directive not be followed.

Very often, a hospital or other facility will access an advance directive and take the information thereon and input some or all of the information into its computer system in a manner that it considers most optimal. This process is often time consuming and labor intensive. It is also often the case that a person enters the facility, and upon entry the facility pulls down from a central database the person's advance directive and inputs the needed information into the hospital's computer system. In the event that the person is released and sometime thereafter re-enters the facility, the facility needs to know if the advance directive information already in the person's file and the information input into the system is the most recent version.

In addition, when the person enters or re-enters the facility, the person or a member of the person's family, a caregivers or a legal representative may bring a hard copy printout of the electronic advance directive. If the person is first entering the facility, the facility needs to know if the hard copy is the most recent version; if the person is re-entering, the facility needs to know if the hard copy is the same as the earlier version entered into the facility computer system, or if there is a more recent version.

The facility may at any time access the central database and access the most recent version. However, there is significant advantage to the facility to limit the time and effort in taking information in the advance directive and inputting that information into the facility's computer system. To such end, once the facility has input the information once, there is only waste in time, effort and money in inputting the same information a second time. Accordingly, the hospital has a great interest in knowing if the advance directive, once input, has changed.

### BRIEF SUMMARY OF THE INVENTION

It is an object of the present invention to provide a system to determine if a particular version of a document is the most recent version of that document.

It is a related object of the present invention to provide a system to determine if there exists a document version later than the version currently being accessed.

Another object of the present invention is to provide an improved system to determine if a document can be relied upon to be the most recent version of that document.

Another object of the present invention is to reduce facility time to input into its system document information that is already the most recent information.

In accordance with a preferred embodiment of the present invention, an improved system to verify the integrity of a document comprises generating a member ID for each member that signs up to draft a document, generating a checksum code upon the member completing the document, associating the checksum and member ID with the completed document, displaying the member ID and checksum with the document, and upon inquiry of a member ID and checksum, the system returning information confirming that document is or is not the most recent version.

Other objects and advantages will become apparent from the following descriptions, taken in connection with the accompanying drawings, wherein, by way of illustration and example, embodiments of the present invention are disclosed.

### BRIEF DESCRIPTION OF THE FIGURES

The novel features believed to be characteristic of the invention are set forth in the appended claims and claims yet to be filed. However, the invention itself, as well as a preferred mode of use and further objectives and advantages thereof, will best be understood by reference to the following detailed description when read in conjunction with the accompanying Figures wherein:

FIG. 1 is a flowchart showing the system generation and display of a checksum code associated with a member ID and an electronic advance directive; and

FIG. 2 is a flowchart showing the system's return of document integrity information in response to a facility inquiry.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

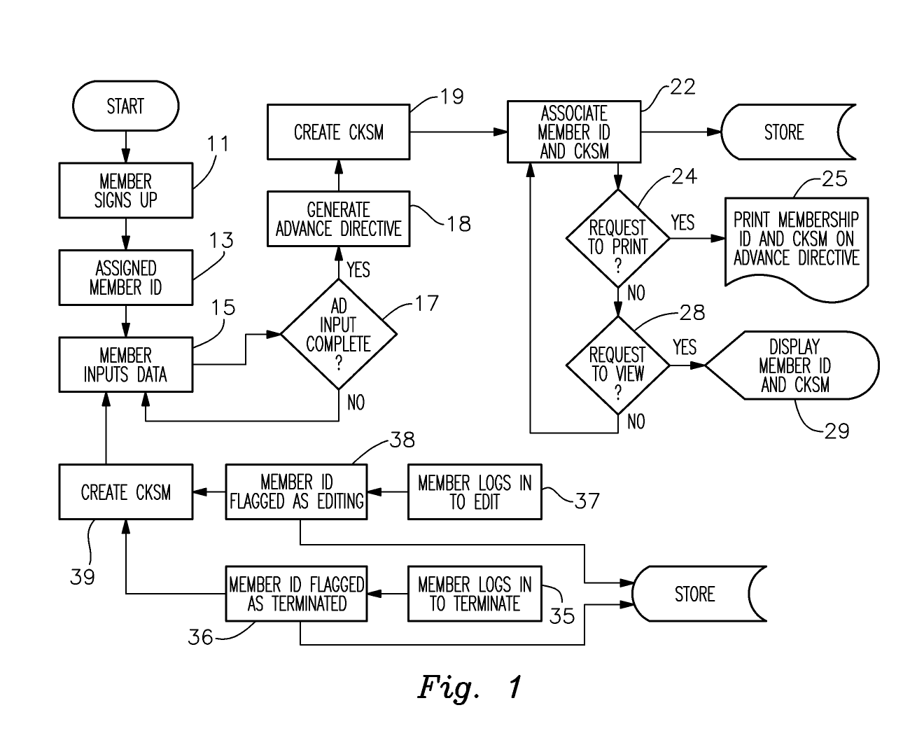

Turning first to FIG. 1, there is a flowchart showing generation and display of a checksum code associated with a member ID and an electronic advance directive for determining the most recent version of a document. The illustrated exemplary system will be described in the context of electronic advance directives, though may be applicable to many types of documents that are revised and for which the integrity of the document needs to be established. In the illustrated embodiment, a person wanting to draft an electronic advance directive signs up with an electronic system that can create, store, and retrieve electronic advance directives, and thereby becomes a member. See FIG. 1 at step 11. Upon signing up, the member is assigned a member ID at step 13. The member, at step 15, then begins to input data about his or her medical treatment goals, preferences and priorities in the event of a health emergency, including various parameters that are included in the final electronic advance directive. This process may take considerable time, as the member may decide to suspend his or her input and resume at a later date for many reasons, including wanting to discuss choices with family members and friends, or simply to consider each decision over time. Accordingly, the system will check to determine if the electronic advance directive for the member is complete at step 17.

If not complete, the system will check again until the member completes entering his or her electronic advance directive information. Upon completion, the system generates an electronic advance directive at step 18, and at step 19 generates a unique checksum alphanumeric string based on various bits of information such as the length of the electronic advance directive, the answers to specific, pre-determined questions, as well as other data. There are many checksum algorithms commercially available that may be employed, depending upon the particular application. In the illustrated embodiment, a modified MD5 checksum is used. It will be appreciated that a variety of unique codes may be generated and associated with the member ID and document, such as a bar or zebra code, a 2-dimensional bar code such as a quick response, or QR, code, or others. The checksum code is then associated with the member ID and the particular electronic advance directive completed by the member and stored. See step 22.

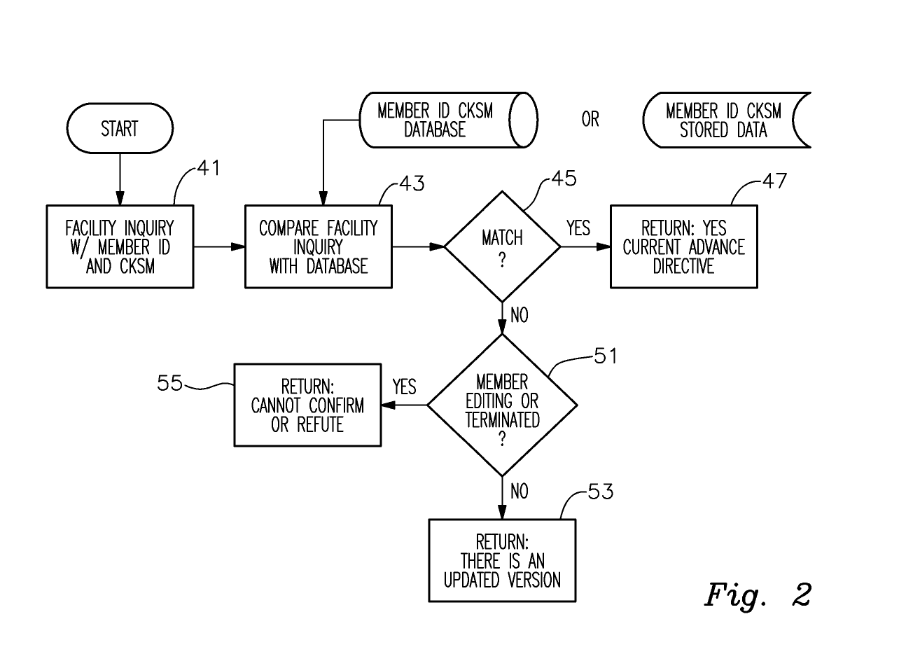

Typically, anyone needing access to the advance directive will either look at a soft copy, i.e., an electronic version on a computer screen, or print the advance directive on paper. The system addresses these two alternatives at steps 24 through 29. If the system is to print a hard copy of the advance directive, step 24, the advance directive is printed with the member ID and the checksum somewhere on the advance directive printout. See step 25. The information may be printed at any location of the document, but in the preferred embodiment, the member ID and checksum alphanumeric string is printed towards the top of the front page of the advance directive along with directions on how to determine whether that the document can or cannot be relied upon to be the most recent and reliable version of the advance directive, as will be described in detail below in connection with FIG. 2. If the advance directive is to be viewed electronically, the member ID and check-sum code is shown in connection with the document. See steps 28 and 29. The information may be displayed in a variety of manners, including as part of the electronic version of the advance directive, as an initial screen check, or otherwise.

A member may also decide that his or her choices have changed or he/she no longer wants to rely on the decisions incorporated into his or her existing advance directive. In such a case, the member can log in to the system to edit the electronic advance directive, step 37. Upon a member deciding to edit his or her electronic advance directive, the system will clearly notify the member that his or her existing electronic advance directive will no longer be in force and effect, and will need verification from the member to proceed. Upon verification, the member ID will be associated with the information that he or she is editing the electronic advance directive, step 38, and the system will generate a new alphanumeric checksum code, step 39. The system stores both the fact that the member is editing the document and the checksum, the import of which will become apparent in connection with the description of FIG. 2, below.

In addition, a member may at some time after creating his or her electronic advance directive decide to terminate his or her membership with the registry electronically storing the advance directive or other document. See step 35. Upon termination, the system at step 36 will associate the member ID with the information that the member has terminated his or her membership, a new alphanumeric checksum code is generated at step 39, and such information is stored.

If the member has logged in to terminate membership at step 35, the loop at steps 15, 17 will never proceed to steps 18, 19, and the checksum generated at step 39 will remain associated with the member ID. If the member has logged in to edit his or her electronic advance directive, the initially generated checksum at step 39 will be associated with the member ID only until the member has completed his or her edits and a new electronic advance directive is complete, at which time a new, unique checksum will be generated and associated with the member ID, as described in detail, above, in connection with steps 15 through 22.

Once the document is printed or displayed, as the case may be, it is important that the document can be verified as to whether it is a document that can be relied upon or not.

Turning next to FIG. 2, there is a flowchart showing the system's return of document integrity information as the result of a facility inquiry. In the illustrated, exemplary embodiment, a facility such as a hospital, nursing home or other health care person or entity will have a member's electronic advance directive, either in paper format, or electronic, and when faced with providing care to the member, will need to know if the advance directive the facility has is an advance directive that can be relied upon.

To verify the integrity of the document, the facility makes an inquiry of the system, step 41, including the member ID and checksum code. The inquiry may be made though a secure web site or otherwise, such as by phone to the electronic advance directive company or directive registry or repository established by the advance directive company. At step 43, the system compares the member ID and checksum code provided by the facility with the system's stored member ID and checksum. At step 45, the comparison will either determine that the information provided by the facility at step 41 matches the system's stored information, step 47, or does not match, steps 51-55. If the facility inquiry information matches the system's stored information, the inquiry returns a message that lets the facility know the document it has, either electronically or in hard copy format, is the most recent version of the document in question and may be relied upon.

If the facility inquiry information does not match the system's stored information, the system proceeds to step 51, where the system determines if the system's stored information includes whether the Member ID is associated with the member editing his or her electronic advance directive, or whether the member has terminated his or her membership. If the member ID is associated with a member who is not editing his or her advance directive or who has not terminated his or her membership, then the advance directive the facility has is an outdated version and has been replaced with a more recent advance directive version for that member. At step 53 the system then returns a message that lets the facility know that the advance directive it has is not the most recent version of the document and that, if the facility is still a subscriber with the electronic advance directive company, it may retrieve the most recent advance directive version at a particular location. If the facility is no longer a subscriber, it may be directed to consult with the member or the member's family, caregivers or legal representatives to obtain the most recent advance directive version. In the exemplar embodiment, a link is provided to the retrieve the most recent advance directive version.

If the member ID is associated with a member who is editing his or her advance directive or with a member who has terminated his or her membership, the system returns a message that lets the facility know that the advance directive it has is not an advance directive that can be relied upon as the most recent and current. In the usual circumstance, the facility would determine the reliability of the advance directive based upon inquiry of the member or the member's family, caregivers or legal representatives. See steps 51, 55.

While the invention has been described in connection with preferred embodiments, it is not intended to limit the scope of the invention to the particular forms set forth, but on the contrary, it is intended to cover such alternatives, modifications, and equivalents as may be included within the spirit and scope of the invention as defined by the appended claims, and claims that may issue.

What is claimed:

1. A system to verify the integrity of a document comprising:
a. one or more members who sign up to draft a document;
b. generating a member ID for each member that signs up to draft a document;
c. generating a checksum code upon member completing document;
d. associating the checksum and member ID with the completed document;
e. displaying member ID and check-sum on document; and
f. upon inquiry of a member ID and checksum, returning information that document is or is not the most recent version.

2. A system to verify the integrity of a document as in claim 1 wherein the checksum is in the form of an alphanumeric string of characters.

3. A system to verify the integrity of a document as in claim 1 wherein the checksum is in the form of a bar code.

4. A system to verify the integrity of a document as in claim 1 wherein the checksum is in the form of a 2-dimensional matrix code.

5. A system to verify the integrity of a document as in claim 1 wherein the checksum is at least in part based on the content of the document.

6. A system to verify the integrity of a document as in claim 1 wherein the checksum is at least in part based on the length of the document.

7. A system to verify the integrity of a document as claimed in claim 1 further comprising: p1 a. the system returns information that the document cannot be verified to be the most recent version.

8. A system to verify the integrity of a document as claimed in claim 1 wherein the document is completed through system inquiry of the member.

9. A system to verify the integrity of a document as claimed in claim 1 wherein the document is completed by input from the member.
